(19) United States
(12) Patent Application Publication
(10) Pub. No.: US 2026/0229536 A1
(43) Pub. Date: Aug. 6, 2026

(54) SULPHIDE BASED LITHIUM-ION CONDUCTING SOLID MATERIALS AND METHODS FOR THE PRODUCTION THEREOF

(71) Applicant: Umicore, Brussels (BE)

(72) Inventors: Antoine BREHAULT, Acigné (FR); Pol BRIANTAIS, Acigné (FR); Yann GUIMOND, Acigné (FR); Alexander Teklit TESFAYE, Olen (BE)

(21) Appl. No.: 19/159,813

(22) PCT Filed: Feb. 29, 2024
(86) PCT No.: PCT/EP2024/055253

§ 371 Date: Aug. 26, 2025

(30) Foreign Application Priority Data
Mar. 1, 2023 (EP) 23290005.0

(51) Int. Cl. H01M 4/62; C01B 35/14; C09D 1/00; C09D 5/24

(52) U.S. Cl. CPC H01M 4/628; C01B 35/14; C09D 1/00; C09D 5/24; C01P 2002/52; C01P 2006/37; C01P 2006/40

(57) ABSTRACT

The present invention relates to solid materials which are obtainable by melt-quenching mixtures of lithium sulphide, boron sulphide, boron oxide and Se, Te, In or a combination thereof, thereby forming a glassy solid which is suitable for use in electrochemical cells, for example as lithium-ion and electronically conducting coating and exhibits a large thermal stability.

### TECHNICAL FIELD AND BACKGROUND

The present invention relates to solid materials which are obtainable by melt-quenching mixtures of lithium sulphide, boron sulphide and boron oxide, thereby forming a glassy solid which is suitable for use as an electrically conductive coating, e.g. an electrode coating. The present invention further relates to methods to prepare said solid materials, to electrochemical cells such as solid-state batteries comprising said solid materials and to uses of the solid material in electrochemical cells such as solid-state batteries, in particular as electrode coating.

The three primary functional components of a lithium-ion battery are the anode, the cathode, and the electrolyte. While many variations exist, the anode of a conventional lithium-ion cell is typically made from carbon, the cathode is typically made from transition metal oxides (in particular oxides of cobalt, nickel and/or manganese), and the electrolyte is typically a non-aqueous solvent containing a lithium salt. For example, mixtures of organic carbonates with lithium hexafluorophosphate are well known liquid electrolytes for lithium-ion batteries.

A significant disadvantage of liquid electrolytes is that the compositions, in particular, the solvents are inflammable, which poses a large safety risk during normal operation and in particular in case of an accident. Another disadvantage is inherent to the liquid nature of the electrolyte, associated with risks of leakage and with increased risk of environmental pollution in case of a spill of leakage.

Recently, efforts have been made to develop solid electrolytes which allow the provision of a solid-state lithium-ion battery. Such solid-state batteries have significantly reduced EHS (environmental, health and safety) hazards. An emerging class of lithium-ion conducting solid electrolytes are sulphide based amorphous solids (interchangeably referred to as glassy solids) such as Li₂S—SiS₂, Li₂S—P₂S₅ or Li₂S—B₂S₃.

A major challenge in the production of glassy solid electrolytes is the avoidance of crystalline regions in the solid material. The thermal stability of a glass ΔTₓ can be characterized as the stability against crystallization, which is determined by the temperature difference between the onset of crystallization (Tₓ) and the glass transition temperature (T_{g}), i.e. ΔTₓ=Tₓ−T_{g}. A larger ΔTₓ is generally associated with improved glass-forming ability and increased glass stability during post-processing.

Another important issue in the development of solid-state batteries with an improved energy density and safety profile, is the deterioration of cell performance resulting from the interfacial reactivity and resulting resistance build-up between the electrodes, in particular the cathode and the solid-state electrolyte (SSE). The interfacial layer formed between the cathode active material (CAM) and the SSE disturbs the transfer of Li ions and electrons resulting in a significant capacity fade and poor C-rate performance. This interfacial instability is one of the main issues limiting the commercialization of all-solid-state batteries (ASSBs).

To mitigate the interfacial resistance between the CAM and the SSE, and the concomitant reduction in cell performance, a buffer layer is often applied to prevent direct contact between the CAM and the electrolyte. In principle, either the electrode or the electrolyte could be coated to stabilise the electrode/electrolyte interface. As the cathode is where ionic conductivity is transformed into electronic conductivity, it is important for such a coating to have sufficient electronic conductivity to prevent inhibition of the cathode functionality.

Early studies on Li₂S—B₂S₃ compositions having a molar ratio of 70:30 and 60:40 reported ΔTₓ values of about 70° C. and about 110° C., respectively (Zhang et al, Solid State Ionics 1990, 38, 217-224).

WO2016/089899 A1 contemplates a plethora of glass systems (many of which are speculative or unsupported). Paragraphs 186 and 188 of WO2016/089899 A1 suggest the addition of oxygen to improve ΔTₓ. Paragraph 190 of WO2016/089899 A1 speculates that Li₂S/Li₂O—B₂S₃—SiS₂ based systems could have a ΔTₓ of greater than 100° C.

WO2020/254314 A1 contemplates sulphide based lithium-ion conducting solid electrolytes of the type Li₂S—B₂S₃ obtained from mixtures further comprising P, Si, Ge, As or Sb oxides in combination with lithium halides. The resulting glassy solids are said to have favourable lithium-ion conductivity as well as electrochemical stability in direct contact with lithium metal and chemical stability against air and moisture. The ΔTₓ of these solids is in the range of 5-36° C. (table 3 of WO2020/254314 A1).

A drawback related to most sulphide based lithium-ion conducting glasses known in the art is that they have either good conductivity or a high ΔTₓ. Presently, there is therefore a significant need to provide sulphide based lithium-ion conducting solid electrolytes combining both properties.

Presently, there is a significant need to provide improved electrolyte or electrode coating materials. In particular, electrode coating materials which exhibit limited chemical reactivity with both the electrolyte and the electrode, reasonable Li-ion conductivity and sufficient electronic conductivity.

It is an object of the present invention to provide improved sulphide based lithium-ion conducting materials which could be used as an electrolyte or an electrode coating, in particular as an electrode coating and which exhibit a high ionic and electronic conductivity. It is another object of the present invention to provide such electrolyte or coating materials having a large ΔTₓ, in particular a ΔTₓ of more than 100° C.

### SUMMARY OF THE INVENTION

The present inventors have found that one or more objects of the invention can be achieved by providing sulphide based lithium-ion conducting solid coatings obtainable by melt-quenching a combination of Li₂S; B₂S₃; B₂O₃ and X in well-defined ratios, wherein X represents Se, Te, In or combinations thereof. As is shown in the appended examples, it is indeed observed that the resulting glassy solids exhibit a high thermal stability ΔTₓ for Li—S based glasses, high ionic conductivities and/or high electrical conductivities.

Accordingly, in a first aspect of the present invention, there is provided a solid material M having a composition according to the general formula (I)

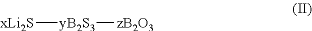

wherein X represents Se, Te, In or combinations thereof;
a is within the range of 0.04 to 0.12;
b is within the range of 0 to 0.04;
c is within the range of 0.12 to 0.26;
d is within the range of 0.001 to 0.17.

In another aspect of the present invention, there is provided a solid material N which is obtainable by melt-quenching a mixture of A and B,
wherein the molar ratio of A and B in the mixture before quenching is within the range of 60:40 to 99:1;
wherein component A is according to the general formula (II)

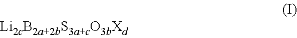

wherein
x is within the range of 55 to 85, preferably within the range of 55 to 75, more preferably within the range of 60 to 70;
y is within the range of 15 to 45, preferably within the range of 20 to 40, more preferably within the range of 25 to 35;
z is within the range of 0 to 15, preferably within the range of 0 to 10, more preferably within the range of 0 to 6, even more preferably within the range of 0 to 5;

$$x + y + z = 100 ;$$

wherein component B is selected from Se, Te, In or combinations thereof.

In another aspect of the present invention, there is provided a method for preparing a solid material, comprising the steps of:
(i) Providing the following precursors:
   Li₂S;
   B₂S₃ and/or both of boron and sulfur;
   Optionally B₂O₃; and
   X wherein X represents Se, Te, In or combinations thereof;
(ii) Preparing a mixture comprising the precursors provided in step (i) wherein
   in said mixture the molar ratio of the elements Li, S, B, O and X matches the general formula (I)

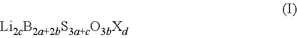

wherein
   a is within the range of 0.04 to 0.12;
   b is within the range of 0 to 0.04;
   c is within the range of 0.12 to 0.26;
   d is within the range of 0.001 to 0.17;
more preferably wherein
   a is within the range of 0.06 to 0.11;
   b is within the range of 0 to 0.04;
   c is within the range of 0.13 to 0.19;
   d is within the range of 0.002 to 0.07, preferably within the range of 0.002 to 0.03;
      or wherein
in said mixture the molar ratio of the precursors matches the general formula (II)

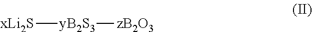

wherein
x is within the range of 55 to 85, preferably within the range of 55 to 75, more preferably within the range of 60 to 70;
y is within the range of 15 to 45, preferably within the range of 20 to 40, more preferably within the range of 25 to 35;
z is within the range of 0 to 15 preferably within the range of 0 to 10, more preferably within the range of 0 to 6, even more preferably within the range of 0 to 5; and

$$x + y + z = 100$$

and in said mixture the molar ratio of A and B, wherein component A is according to the general formula (II), wherein component B is selected from Se, Te, In or combinations thereof, is within the range of 60:40 to 99.5:0.5;
(iii) heat-treating the mixture prepared in step (ii) to obtain a melt; and
(iv) quenching the melt obtained in step (iii) to obtain the solid material.

In another aspect of the invention, there is provided a solid composition comprising a first solid material which is the solid material M and/or N as described herein, and further comprising at least a second solid material having a different composition than the first solid material.

In another aspect of the invention, there is provided an electrochemical cell comprising the solid material as described herein.

In another aspect of the invention, there is provided the use of the solid material M and/or N as described herein, or of the solid composition as described herein, as a solid electrolyte for an electrochemical cell or as a coating for an electrochemical cell component. For example, the use as a coating for electrode or electrolyte material is provided.

Another aspect of the present invention concerns batteries, more specifically a lithium-ion battery or a lithium metal battery or a lithium solid-state battery comprising at least one electrochemical cell comprising the solid material M and/or N as described herein, for example, two or more electrochemical cells as described herein.

A further aspect of the present invention is a method for making or operating cars, computers, personal digital assistants, mobile telephones, watches, camcorders, digital cameras, thermometers, calculators, laptop BIOS, communication equipment, satellites, remote car locks, and stationary applications such as energy storage devices for power plants by employing at least one battery or at least one electrochemical cell comprising the solid material as described herein.

A further aspect of the present disclosure is the use of the electrochemical cell comprising the solid material of the invention in motor vehicles, bicycles operated by electric motor, robots, aircraft (for example unmanned aerial vehicles including drones), ships, satellites or stationary energy stores.

In another aspect of the invention there is provided the use of Se, Te, In, or combinations thereof,
for improving the thermal stability ΔTₓ of a glassy solid, in particular for improving the thermal stability ΔTₓ of a sulphide based lithium-ion conducting solid electrolyte or coating; or
for improving the ionic and/or electronic conductivity of a sulphide-based lithium-ion conducting solid electrolyte or coating.
glassy solids in particular sulphide based amorphous solids such as Li₂S—SiS₂, Li₂S—P₂S₅ or Li₂S—B₂S₃.

### DETAILED DESCRIPTION OF THE INVENTION

In the following detailed description, preferred embodiments are described in detail to enable the practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

The glass transition temperature (T_{g}), as referred to herein, refers to the temperature of the onset of glass transition as determined by Differential Scanning Calorimetry (DSC). It is preferably determined by constructing tangents to the DSC curve baselines before and after the glass transition and determining the extrapolated onset temperature by the intersection of these tangents, essentially corresponding to the temperature where the highest slope in the drop of the DSC baseline occurs before the exothermic crystallization peak. The DSC is preferably recorded using the following temperature profile: from 100° C. to 350° C. at a rate of 10° C./min, and preferably it is recorded on a 5-10 mg sample in a sealed aluminium pan. A suitable DSC apparatus is a DSC 3500 Sirius.

The thermal stability (ΔTₓ) as referred to herein is the difference between the crystallization onset temperature as determined by DSC (Tₓ) and the glass transition temperature as determined by DSC (T_{g}). In other words: ΔTₓ=Tₓ−T_{g}. As explained in the previous paragraph, the glass transition temperature (T_{g}), as referred to herein, refers to the temperature of the onset of glass transition as determined by Differential Scanning Calorimetry (DSC).

The ionic conductivity as referred to herein, refers to the ionic conductivity determined by electrochemical impedance spectroscopy (EIS) at 25° C. It is preferably determined with ion-blocking electrodes on hot pressed samples which were densified at 350 MPa at 125° C. for 5 min after which the ionic conductivity was measured at 25° C. under an operational pressure of 125 MPa. Preferably an excitation voltage of 10 mV was applied in the frequency range of 7 MHz-1 Hz and the data was interpreted by means of an equivalent circuit analysis. A suitable conductivity analyzer is a potentiostat with frequency analyzer such as is available from Biologic.

The electronic conductivity as referred to herein, refers to the electronic conductivity determined at 25° C. It is preferably determined with ion-blocking electrodes on hot pressed samples which were densified at 350 MPa at 125° C. for 5 min after which the electronic conductivity was measured at 25° C. under an operational pressure of 125 MPa. Preferably the electronic conductivity was measured via stepwise potentiostatic polarization at 0.2, 0.4 and 0.6 V for 20 min. A suitable conductivity analyzer is a potentiostat with frequency analyzer such as is available from Biologic.

The Se, Te or In as referred to herein concern elemental Se, Te or In. The present inventors have found that when the elemental form of these materials is mixed with the glass forming components Li₂S, B₂S₃ and B₂O₃ this results in the materials of the present invention, which have particular and improved properties (as is explained throughout this application), which properties are distinct from the properties obtained when e.g. oxides of these materials are used.

In a first aspect of the present invention, there is provided a solid material M having a composition according to the general formula (I)

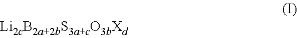

Wherein X represents Se, Te, In or combinations thereof;
a is within the range of 0.04 to 0.12;
b is within the range of 0 to 0.04;
c is within the range of 0.12 to 0.26;
d is within the range of 0.001 to 0.17.
   Without wishing to be bound by any theory, the present inventors believe that the solid materials M according to formula (I) are the result obtained when melt quenching a mixture of Li₂S; B₂S₃; B₂O₃ and X, wherein X represents Se, Te, In or combinations thereof, as is explained herein in the context of other aspects of the invention, and in the examples.

The solid material M having a composition according to general formula (I) is preferably provided wherein
a is within the range of 0.04 to 0.12;
b is within the range of 0 to 0.04;
c is within the range of 0.12 to 0.21;
d is within the range of 0.001 to 0.17.
   more preferably wherein
a is within the range of 0.06 to 0.11;
b is within the range of 0 to 0.04;
c is within the range of 0.13 to 0.19;
d is within the range of 0.002 to 0.07, preferably within the range of 0.002 to 0.03; and
   more preferably wherein
a is within the range of 0.06 to 0.10;
b is within the range of 0.002 to 0.02, preferably within the range of 0.005 to 0.02;
c is within the range of to 0.13 to 0.19;
d is within the range of 0.002 to 0.07, preferably within the range of 0.002 to 0.03.
   In general, it is preferred that d is within the range of 0.002 to 0.06, preferably within the range of 0.002 to 0.03, more preferably within the range of 0.01 to 0.03. Most preferably d is within the range of 0.011 to 0.023.

In each of the embodiments of the composition according to general formula (I) described herein, the molar ratios may be calculated such that the total of 5a+5b+3c+d is within the range of 0.9-1.1, preferably within the range of 0.99-1.01, most preferably about 1.

The solid material M having a composition according to general formula (I), if prepared by e.g. melt-quenching, may be accompanied by minor amounts of impurity phases which typically mainly consist of the precursors used for preparing the solid or intermediated formed from said precursors.

In a second aspect of the present invention, there is provided a solid material N which is obtainable by melt-quenching a mixture of A and B,
wherein the molar ratio of A and B in the mixture before quenching is within the range of 60:40 to 99:1;
wherein component A is according to the general formula (II)

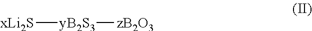

wherein
x is within the range of 55 to 85, preferably within the range of 55 to 75, more preferably within the range of 60 to 70;
y is within the range of 15 to 45, preferably within the range of 20 to 40, more preferably within the range of 25 to 35;
z is within the range of 0 to 15, preferably within the range of 0 to 10, more preferably within the range of 0 to 6, even more preferably within the range of 0 to 5;

$$x + y + z = 100 ;$$

wherein component B is selected from Se, Te, In or combinations thereof.

In preferred embodiments of the invention, the solid material N is obtainable by melt-quenching a mixture of A and B is provided wherein
x is within the range of 62 to 68, preferably within the range of 63 to 67, more preferably within the range of 64 to 66;
y is within the range of 27 to 33, preferably within the range of 28 to 32, more preferably within the range of 29 to 31;
z is within the range of 1 to 8, preferably within the range of 3 to 7, more preferably within the range of 4 to 7, even more preferably within the range 4 to 6; and

$$x + y + z = 100.$$

In accordance with highly preferred embodiments of the invention, the solid material N which is obtainable by melt-quenching a mixture of A and B is provided wherein
x is about 65;
y is about 30; and
z is about 5.

In general, it is preferred that the molar ratio of A and B in the mixture before quenching is within the range of 72:25 to 98:2, preferably within the range of 80:20 to 98:2, more preferably within the range of 85:15 to 96:4, most preferably within the range of 90:10 to 96:4. Most preferably the molar ratio of A and B in the mixture before quenching is within the range of 92:8 to 98:2, such as 92:8 to 96:4.

Hence, in some embodiments of the invention, the solid material N which is obtainable by melt-quenching a mixture of A and B is provided wherein
x is within the range of 62 to 68, preferably within the range of 63 to 67, more preferably within the range of 64 to 66;
y is within the range of 27 to 33, preferably within the range of 28 to 32, more preferably within the range of 29 to 31;
z is within the range of 1 to 8, preferably within the range of 3 to 7, more preferably within the range of 4 to 6;

$$x + y + z = 100 ;$$

and
the molar ratio of A and B in the mixture before quenching is within the range of 75:25 to 98:2, preferably within the range of 80:20 to 98:2, more preferably within the range of 85:15 to 96:4, most preferably within the range of 90:10 to 96:4. Most preferably the molar ratio of A and B in the mixture before quenching is within the range of 92:8 to 98:2, such as 92:8 to 96:4.

In some embodiments of the invention the solid material N which is obtainable by melt-quenching a mixture of A and B is provided wherein
x is about 65;
y is about 30;
z is about 5;

$$x + y + z = 100 ;$$

and
the molar ratio of A and B in the mixture before quenching is within the range of 75:25 to 98:2, preferably within the range of 80:20 to 98:2, more preferably within the range of 85:15 to 96:4, most preferably within the range of 90:10 to 96:4, most preferably about 95:5.

Without wishing to be bound by any theory it is believed that in general and thus in some preferred embodiments of the invention, the solid material N which is obtainable by melt-quenching a mixture of A and B as described herein is the solid material having a composition according to general formula (I) as described herein.

The solid material N according to the different aspects of the invention described herein, namely the solid material having a composition according to general formula (I) as described herein and the solid material which is obtainable by melt-quenching a mixture of A and B as described herein (i.e. the solid material of embodiment 2), are collectively referred to as “the solid material”.

In accordance with preferred embodiments of the invention, the solid material N is provided wherein X represents Se. As shown in the appended examples, these materials exhibit high electronic and ionic conductivities as well as a high thermal stability. In these embodiments, it is particularly preferred that the solid material N of the invention is a composition according to general formula (I) as described herein wherein d is within the range of 0.008 to 0.01, preferably within the range of 0.01 to 0.03, or that the solid material of the invention is obtainable by melt-quenching a mixture of A and B as described herein wherein the molar ratio of A and B in the mixture before quenching is within the range of 85:15 to 96:4, most preferably within the range of 90:10 to 96:4.

In accordance with preferred embodiments of the invention, the solid material N is provided wherein X represents Te. As shown in the appended examples, these materials exhibit high ionic conductivities as well as a high thermal stability. In these embodiments, it is particularly preferred that the solid material N of the invention is a composition according to general formula (I) as described herein wherein d is within the range of 0.008 to 0.01, preferably within the range of 0.01 to 0.03, or that the solid material of the invention is obtainable by melt-quenching a mixture of A and B as described herein wherein the molar ratio of A and B in the mixture before quenching is within the range of 85:15 to 96:4, most preferably within the range of 90:10 to 96:4.

The solid materials of the present invention are typically glassy solids, obtainable by melt-quenching a mixture of precursors. In some embodiments, the solid materials are in the form of a monolithic glass, such as a melt-cast monolithic glass. It is preferred that the glassy solid is essentially free of crystalline phases. This may mean than in some embodiments the amount of crystalline phases as determined by X-ray diffraction is less than 5 vol % of the solid material, preferably less than 2 vol %, more preferably less than 1 vol %. A phase is considered crystalline if the intensity of its reflection if more than 10% above the background.

It was found that the solid materials of the present invention have a surprisingly high electronic conductivity which makes them extremely attractive materials for coating solid state battery components, such as electrode or electrolyte materials, in particular electrode materials. In accordance with preferred embodiments of the invention, the solid material is provided wherein the material has an electronic conductivity at 25° C. of at least 5×10⁻⁵ mS/cm, preferably at least 7×10⁻⁵ mS/cm. As is shown in the appended examples the present inventors have surprisingly found that in case at least 50 mol % of X represents Se, preferably at least 80 mol % of X represents Se, most preferably X represents Se, the electronic conductivity at 25° C. can be as high as 1.64×10⁻⁴ mS/cm. Hence, in some embodiments of the invention, the solid material is provided wherein the material has an electronic conductivity at 25° C. of at least 5.61×10⁻⁵ mS/cm, preferably at least 7.9×10⁻⁵ mS/cm, more preferably at least 1×10⁻⁴ mS/cm, most preferably 1.5×10⁻⁴ mS/cm. In particular embodiments of the invention:
at least 50 mol % of X represents Se, preferably at least 80 mol % of X represents Se, most preferably X represents Se; and
the solid material has an electronic conductivity at 25° C. of at least 5.61×10⁻⁵ mS/cm, preferably at least 7.9×10⁻⁵ mS/cm, more preferably at least 1×10⁻⁴ mS/cm, most preferably 1.5×10⁻⁴ mS/cm.
   For example in some embodiments of the solid material of the invention, at least 80 mol % of X represents Se and the electronic conductivity at 25° C. of the solid material is at least 6.9×10⁻⁵ mS/cm, or X represents Se and the electronic conductivity at 25° C. of the solid material is at least 7.9×10⁻⁵ mS/cm, such as at least 1×10⁻⁴ mS/cm or at least 1.5×10⁻⁴ mS/cm.

It was found that the solid materials M and/or N of the present invention combine said high electronic conductivity with high ionic conductivity. In accordance with preferred embodiments of the invention, the solid material is provided wherein the material has an ionic conductivity at 25° C. of more than 0.1 mS/cm, preferably more than 0.25 mS/cm and an electronic conductivity at 25° C. of at least 5×10⁻⁵ mS/cm, preferably at least 7×10⁻⁵ mS/cm. As is shown in the appended examples the present inventors have surprisingly found that in case X represents Se, the electronic conductivity at 25° C. can be very high, such as more than 1×10⁻⁴ mS/cm or even more than 1.5×10⁻⁴ mS/cm. Hence, in some embodiments of the invention, the solid material is provided wherein the material has an ionic conductivity at 25° C. of more than 0.1 mS/cm, preferably more than 0.25 mS/cm and an electronic conductivity at 25° C. of more than 1×10⁻⁴ mS/cm, preferably more than 1.5×10⁻⁴ mS/cm. In particular embodiments of the invention:
at least 50 mol % of X represents Se, preferably at least 80 mol % of X represents Se, most preferably X represents Se;
the solid material has an ionic conductivity at 25° C. of more than 0.1 mS/cm; and
the solid material has an electronic conductivity at 25° C. of more than 1×10⁻⁴ mS/cm, preferably more than 1.5×10⁻⁴ mS/cm.

As is shown in the appended examples, it was found that the glassy solids of the present invention exhibit an extremely high thermal stability ΔTₓ. In accordance with preferred embodiments of the invention, the solid materials M and/or N are provided wherein the material has a thermal stability ΔTₓ of more than 100° C., preferably more than 110° C., more preferably more than 115° C. In some embodiments, particularly when X represents Se, Te or a combination thereof, the thermal stability ΔTₓ is more than 120° C.

In certain highly preferred embodiments, the solid materials M and/or N of the invention are provided wherein
the solid material has an ionic conductivity at 25° C. of at least 0.1 mS/cm, preferably at least 0.3 mS/cm;
the solid material has a thermal stability ΔTₓ of more than 100° C., preferably more than 110° C., more preferably more than 115° C.; and
preferably the solid material has an electronic conductivity at 25° C. of more than 1×10⁻⁴ mS/cm, preferably more than 1.5×10⁻⁴ mS/cm.

As is explained throughout the present application, the solid materials M and/or N of the invention are obtainable by melt-quenching a mixture of precursors to obtain a glassy solid. For some applications, it may be preferable that the material is provided in the form of a particulate solid, such as a powder. This may facilitate blending with e.g. cathode material. The solid may be obtained directly in the form of a particulate solid (such as a powder) or may be comminuted (such as by milling, grinding, etc.) to a particulate solid (such as a powder). For other applications it may be preferable that the solid material is provided in the form of a thin sheet or film, preferably a sheet or film having a thickness of less than 500 micron, preferably less than 100 micron.

The present inventors contemplate that the addition of small amounts of other materials during synthesis in such a way that the general formula (I) of the resulting solid material M is no longer respected or in such a way that the general formula (II) of the resulting material N is no longer respected; but wherein the changes do not materially affect the basic and novel characteristic(s) of the solid materials of the invention is possible. Such modifications, that are in fact impurities, are considered within the scope of the general formula (I) or (II) for the purposes of the present invention.

In a third aspect of the present invention, there is provided a method for preparing a solid materials, comprising the steps of:
(i) Providing the following precursors:
   Li₂S;
   B₂S₃ and/or both of boron and sulfur;
   Optionally B₂O₃; and
   X wherein X represents Se, Te, In or combinations thereof;
(ii) Preparing a mixture comprising the precursors provided in step (i) wherein
   in said mixture the molar ratio of the elements Li, S, B, O and X matches the general formula (I)

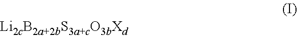

a is within the range of 0.04 to 0.12,
b is within the range of 0 to 0.04;
c is within the range of 0.12 to 0.26;
d is within the range of 0.001 to 0.17; or
   in said mixture the molar ratio of the precursors matches the general formula (II)

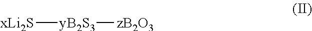

wherein
x is within the range of 55 to 85;
y is within the range of 15 to 45;
z is within the range of 0 to 15; and

$$x + y + z = 100$$

and in said mixture the molar ratio of A and B, wherein component A is according to the general formula (II), wherein component B is selected from Se, Te, In or combinations thereof, is within the range of 60:40 to 99.5:0.5;
(iii) heat-treating the mixture prepared in step (ii) to obtain a melt; and
(iv) quenching the melt obtained in step (iii) to obtain the solid material.

This method is generally referred to as the melt-quench method of the invention. The process is cost-effective and easily scalable. The preferred embodiments of the general formula (I), in particular of a, b, c and d described herein in the context of the materials of the invention, are equally applicable to the method for preparing a solid material M. Similarly, the preferred embodiments of the general formula (II), in particular of x, y and z described herein in the context of the second aspect of the invention, are equally applicable to the melt-quench method of the invention, for preparing a solid material N. Additionally, the preferred embodiments of the solid materials of the invention (i.e. of the first and second aspect of the invention) in general (e.g. regarding the identity of X, the conductivities, the thermal stability etc.) are equally applicable to the melt-quench method of the third aspect of the invention.

Preferably, the mixture of step (ii) is a mixture of A and B, wherein component A is according to the general formula (II), wherein component B is selected from Se, Te, In or combinations thereof, and wherein the ratio of A and B in the mixture before quenching is within the range of 60:40 to 99:1, it is preferred that the molar ratio of A and B in the mixture before quenching is within the range of 72:25 to 98:2, preferably within the range of 80:20 to 98:2, more preferably within the range of 85:15 to 96:4, most preferably within the range of 90:10 to 96:4. Most preferably the molar ratio of A and B in the mixture before quenching is within the range of 92:8 to 98:2, such as 92:8 to 96:4.

The provision of both of boron and sulfur in step (i) should be interpreted to mean the provision of elemental boron and elemental sulfur. The elemental boron and elemental sulfur may be provided in in amorphous or crystalline form, wherein the specific allotrope used is not particularly limiting for the invention.

Preparing the mixture of step (ii) may be performed by any suitable means, preferably by mechanical milling (e.g. ball milling).

Step (iii) involves heating the mixture prepared in step (ii) to obtain a melt, i.e. heat-treating at a temperature above the melting temperature of the mixture prepared in step (ii). Step (iii) preferably comprises heat-treating the mixture prepared in step (ii) at a temperature of at least 400° C., preferably at least 600° C., more preferably at least 800° C. The mixture is preferably kept at this temperature for at least 15 minutes, preferably at least 30 minutes, more preferably at least 2 hours.

Heat-treating may be performed in a closed vessel. The closed vessel may be a sealed quartz tube or any other type of container which is capable of withstanding the temperature of the thermal treatment and is not subject to reaction with the constituents of the glass, such as a closed vessel made from a material selected from magnesium oxide, boron nitride, copper, tungsten, silicon nitride, aluminium nitride, carbon and combinations thereof. The heat treatment of step (iii) may be a single-stage or a multiple-stage heat treatment.

It is preferred that step (iii) is performed under an inert gas atmosphere, preferably an inert atmosphere comprising one or more noble gases (such as argon) and/or at a pressure of less than 1 atm, preferably of less than 0.1 atm, more preferably of less than 0.01 atm. Typically and thus preferably, step (iii) is performed at a pressure of less than 10-4 atm, preferably less than 10-5 atm and preferably under an inert gas atmosphere, preferably an inert atmosphere comprising one or more noble gases (such as argon). The use of nitrogen as inert atmosphere is generally to be avoided in view of potential reaction with the glass precursors.

It is highly preferred that the melt-quench method of the invention is for the preparation of the solid material described herein.

In some embodiments of the melt-quench method of the invention (iv) further comprises the steps of:
(iv)a quenching the melt obtained in step (iii) to obtain solid material;
(iv)b pulverising the solid material of step (iv) to obtain a particulate solid, such as a powder; and
(iv)c optionally forming a thin film or sheet, preferably a film or sheet having a thickness of less than 500 micron, preferably less than 100 micron by:
   Dissolving or suspending the particulate solid of step (iv)b in a liquid phase to obtain a solution or suspension, followed by deposition from the solution or suspension to obtain the thin film or sheet; or
   Reheating the particulate solid of step (iv)b to a temperature sufficient to allow drawing a film or sheet, and drawing said film or sheet.
      In alternative embodiments step (iv) comprises quenching the melt of step (iii) while maintaining the temperature sufficiently high to allow drawing a thin film or sheet, and drawing said film or sheet, preferably drawing a film or sheet having a thickness of less than 500 micron, preferably less than 100 micron.

It is preferred that the method is operated in the form of a continuous process to produce a continuous glass film or sheet which is cut to a desired size.

The step of quenching in step (iv) is preferably performed by contacting the melt obtained in step (iii) directly, or by contacting the vessel while closed or opened (preferably while closed), with water, ice, an optionally cooled gas (such as air), an optionally cooled metal plate (such as via roller quenching), and/or a chemically inert mould.

In another aspect of the invention, there is provided with a solid composition comprising a first solid material which is the solid material as described herein, and further comprising at least a second solid material having a different composition than the first solid material.

The first solid material may be present in the form of discrete particles embedded in a matrix of the second solid material. Alternatively, the first solid material and the second solid material may be present in the form of discrete particles which have been blended, optionally in combination with a binder material and one or more further materials, and wherein the blend is preferably compacted.

Alternatively, the first solid material and/or the second solid material may be present in the form of different layers of a multilayer thin sheet or film, preferably a multilayer thin sheet or film having a total thickness of less than 500 micron, preferably less than 200 micron. It is highly preferred that the first solid material (which is the solid material as described herein) is coated on a second solid material. This is particularly useful in case the second solid material is an electrochemical cell component such as a solid electrolyte or an electrode (in particular a cathode).

In another aspect of the invention, there is provided an electrochemical cell comprising the solid material as described herein.

In particular, there is provided an electrochemical cell wherein the cathode, anode, separator and/or coatings thereof, comprises the solid material as defined herein. In particularly preferred embodiments of the invention, there is provided an electrochemical cell wherein the solid material of the present invention is provided in the form of a coating, in particular in the form of a coating on an electrode material, such as the cathode material. In some embodiments, the separator consists of the solid material as described herein.

In another aspect of the invention, there is provided the use of the solid material as described herein or of the solid composition as described herein, as a solid electrolyte for an electrochemical cell or as a coating for an electrochemical cell component. For example, the use of the solid material of the invention as a coating for electrode or electrolyte material is provided, in particular the use of the solid material of the invention as a coating for electrode material is provided.

In the context of the various aspects of the invention described herein, suitable electrochemically active cathode materials and suitable electrochemically active anode materials are those known in the art. For example, the anode may comprise graphitic carbon, metallic lithium or a metal alloy comprising lithium as the anode active material. For example, the cathode may comprise a Nickel-Cobalt or a Nickel-Manganese-Cobalt cathode material. Electrochemical cells as described herein are preferably lithium-ion containing cells wherein the charge transport is affected by Li⁺ ions. The electrochemical cell may have a disc-like or prismatic shape. The electrochemical cells can include a housing that can be from steel or aluminium. A plurality of electrochemical cells may be combined into an all solid-state battery, which has both solid electrodes and solid electrolytes.

Another aspect of the present invention concerns batteries, more specifically a lithium-ion battery or a lithium metal battery or a lithium solid-state battery comprising at least one electrochemical cell comprising the solid material as described herein, for example two or more electrochemical cells as described herein.

Electrochemical cells as described herein can be combined with one another, for example in series connection or in parallel connection. Series connection is preferred. The electrochemical cells resp. batteries described herein can be used for making or operating cars, computers, personal digital assistants, mobile telephones, watches, camcorders, digital cameras, thermometers, calculators, laptop BIOS, communication equipment, satellites or remote car locks, and stationary applications such as energy storage devices for power plants.

A further aspect of the present invention is a method for making or operating cars, computers, personal digital assistants, mobile telephones, watches, camcorders, digital cameras, thermometers, calculators, laptop BIOS, communication equipment, satellites, remote car locks, and stationary applications such as energy storage devices for power plants by employing at least one battery or at least one electrochemical cell comprising the solid material as described herein.

A further aspect of the present disclosure is the use of the electrochemical cell comprising the solid material of the invention in motor vehicles, bicycles operated by electric motor, robots, aircraft (for example unmanned aerial vehicles including drones), satellites, ships or stationary energy stores.

The present invention further provides a device comprising at least one electrochemical cell as described herein. Preferred are mobile devices such as vehicles, for example automobiles, bicycles, aircraft, satellites, or water vehicles such as boats or ships. Other examples of mobile devices are those which are portable, for example computers, especially laptops, telephones or electrical power tools, for example from the construction sector, especially drills, battery-driven screwdrivers or battery-driven tackers.

In another aspect of the invention there is provided the use of Se, Te, In, or combinations thereof,
for improving the thermal stability ΔTₓ of a glassy solid, in particular for improving the thermal stability ΔTₓ of a sulphide based lithium-ion conducting solid electrolyte or coating, preferably coating; or
for improving the ionic and/or electronic conductivity of a sulphide-based lithium-ion conducting solid electrolyte or coating, preferably coating.

Without wishing to be bound by any theory, the present inventors believe that the use of the materials described herein as a cathode coating improves the electrochemical stability, chemical stability, Li-ion mobility and general performance and longevity (such as tested through long-term cycling performance) when utilised in an electrochemical cell.

### EXAMPLES

### 1. Preparation of Materials

For each example, 15 g of final material has been produced using the following starting products: amorphous B₂S₃ (99 wt. %), Li₂S (99.9 wt. %) and B₂O₃ (99.95 wt. %) and X (detailed in the below table). In an argon filled glovebox, appropriate amounts of starting materials were weighed, mixed and introduced in a carbon coated silica ampoule. The tube was sealed and introduced in a vertical rocking furnace. The melt was homogenized for 30 minutes at an internal temperature of 950° C. and then quenched in water at room temperature. The ampoule was then opened in the argon filled glovebox. Glassy material was obtained having yellow, orange or brown color with good transparency.

### 2. Determination of Thermal Stability ΔTₓ

Thermal analysis was performed with Differential Scanning Calorimetry DSC 3500 Sirius. A sample of between 5 and 10 mg of the glassy material was placed in a sealed aluminum pan and analyzed using the following temperature profile: from 100° C. to 350° C. at a rate of 10° C./min. For every sample, the glass transition temperature (T_{g}) and the onset of crystallization (Tₓ) was determined. The thermal stability was then estimated from a simple difference between those values (ΔTₓ=Tₓ−T_{g}).

The glass transition temperature (T_{g}) was determined by constructing tangents to the DSC curve baselines before and after the glass transition and determining the extrapolated onset temperature by intersection of these tangents, essentially corresponding to the temperature where the highest slope in the drop of the DSC baseline occurs before the exothermic crystallisation peak. The T_{g} onset temperature determined in this way was used as the T_{g}.

### 3. Determination of Conductivity

Ionic conductivity was measured by electrochemical impedance spectroscopy (EIS) at room temperature (25° C.) on hot pressed samples in a pellet cell with ion blocking electrodes. The samples were densified at 350 MPa at 125° C. for 5 min. The ionic conductivity was measured under an operational pressure of 125 MPa. For the EIS an excitation voltage of 10 mV was applied in the frequency range of 7 MHz-1 Hz. The data was interpreted by means of an equivalent circuit analysis.

Electronic conductivity was measured at room temperature (25° C.) on hot pressed samples in a pellet cell with ion blocking electrodes. The samples were densified at 350 MPa at 125° C. for 5 min. The electronic conductivity was measured under an operational pressure of 125 MPa. The electronic conductivity was measured via stepwise potentiostatic polarization at 0.2, 0.4 and 0.6 V for 20 min.

Both measurements were conducted with a potentiostat with frequency analyzer (Biologic).

### 4. Results

TABLE 1
overall formulas of the synthesized compositions

| | Component A | | | | Molar | |
|---|---|---|---|---|---|---|
| | Li₂S | B₂S₃ | B₂O₃ | Component B | ratio A:B | Overall formula |
| Comparative | 65 | 30 | 5 | / | / | Li_{0.35}B_{0.19}S_{0.42}O_{0.04} |
| Example 1 | | | | | | |
| Example 2 | 65 | 30 | 5 | Te | 98:2 | Li_{0.35}B_{0.19}S_{0.42}O_{0.04}Te_{0.01} |
| Example 3 | 65 | 30 | 5 | Te | 95:5 | Li_{0.35}B_{0.19}S_{0.41}O_{0.04}Te_{0.01} |
| Example 4 | 65 | 30 | 5 | Se | 98:2 | Li_{0.35}B_{0.19}S_{0.42}O_{0.04}Se_{0.01} |
| Example 5 | 65 | 30 | 5 | Se | 95:5 | Li_{0.35}B_{0.19}S_{0.41}O_{0.04}Se_{0.01} |
| Example 6 | 65 | 30 | 5 | In | 98:2 | Li_{0.35}B_{0.19}S_{0.42}O_{0.04}In_{0.01} |

TABLE 2
Tₓ, T_{g}, ionic conductivity and electronic
conductivity of each composition;

| | | | | Ionic | Electronic |
|---|---|---|---|---|---|
| | Tₓ | T_{g} | ΔTₓ | conductivity | conductivity |
| | (° C.) | (° C.) | (° C.) | (mS/cm) | (mS/cm) |
| Comparative | 312 | 196 | 116 | 0.1 | 5.61 × 10⁻⁵ |
| Example 1 | | | | | |
| Example 2 | 317 | 192 | 125 | 0.54 | 1.6 × 10⁻⁵ |
| Example 3 | 321 | 195 | 126 | NA | NA |
| Example 4 | 314 | 198 | 116 | 0.33 | 7.9 × 10⁻⁵ |
| Example 5 | 311 | 189 | 122 | 0.25 | 1.64 × 10⁻⁴ |
| Example 6 | 318 | 210 | 108 | 0.64 | 8.99 × 10⁻⁶ |

NA = not available

As can be seen from table 2, when comparing Examples 2 to 6, which are according to the present invention, to Comparative Example 1, which is not according to the present invention, thermal stability increase, ionic conductivity increase and/or electronic conductivity decrease were advantageously obtained. Additionally, as can be seen from table 2, thermal stability increases going from In to Se to Te. Higher ionic conductivities were achieved at higher A:B ratios. Electronic conductivity decreases going from Te to Se to In.

1. A solid material having a composition according to the general formula (I) 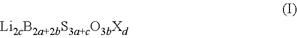
Wherein X represents Se, Te, In or combinations thereof;
a is within the range of 0.04 to 0.12;
b is within the range of 0 to 0.04;
c is within the range of 0.12 to 0.26;
d is within the range of 0.001 to 0.17.

2. The solid material according to any one of the previous claims wherein
a is within the range of 0.04 to 0.12;
b is within the range of 0 to 0.04;
c is within the range of 0.12 to 0.21;
d is within the range of 0.001 to 0.17.

3. The solid material according to any one of the previous claims wherein
a is within the range of 0.06 to 0.11;
b is within the range of 0 to 0.04;
c is within the range of 0.13 to 0.19;
d is within the range of 0.002 to 0.07, preferably within the range of 0.002 to 0.03.

4. The solid material according to any one of the previous claims wherein
a is within the range of 0.06 to 0.10;
b is within the range of 0.002 to 0.02, preferably within the range of 0.005 to 0.02;
c is within the range of to 0.13 to 0.19;
d is within the range of 0.002 to 0.07, preferably within the range of 0.002 to 0.03.

5. The solid material according to any one of the previous claims wherein d is within the range of 0.002 to 0.06, preferably within the range of 0.002 to 0.03, more preferably within the range of 0.01 to 0.03.

6. The solid material according to any one of the previous claims wherein X is Se and d is within the range of 0.008 to 0.01, preferably within the range of 0.01 to 0.03.

7. The solid material according to any one of the previous claims wherein 5a+5b+3c+d=1.

8. A solid material, preferably the solid material according to any one of the previous claims, which is obtainable by melt-quenching a mixture of A and B, wherein the molar ratio of A and B in the mixture before quenching is within the range of 60:40 to 99.5:0.5;
Wherein component A is according to the general formula (II) 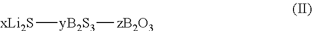
wherein
x is within the range of 55 to 85, preferably within the range of 55 to 75, more preferably within the range of 60 to 70;
y is within the range of 15 to 45, preferably within the range of 20 to 40, more preferably within the range of 25 to 35;
z is within the range of 0 to 15, preferably within the range of 0 to 10, more preferably within the range of 0 to 6, even more preferably within the range of 0 to 5;
$$x + y + z = 100 ;$$
and
wherein component B is selected from Se, Te, In or combinations thereof.

9. The solid material according to claim 8 wherein
x is within the range of 57 to 80, preferably within the range of 60 to 70, more preferably within the range of 65 to 70;
y is within the range of 27 to 35, preferably within the range of 28 to 32, more preferably within the range of 29 to 31;
z is within the range of 1 to 5, preferably within the range of 2 to 7, more preferably within the range of 4 to 7, even more preferably within the range of 4 to 6; and
$$x + y + z = 100.$$

10. The solid material according to any one of claim 8 or 9 wherein the molar ratio of A and B in the mixture before quenching is within the range of 70:30 to 98:2 preferably within the range of 80:20 to 98:2, more preferably within the range of 85:15 to 96:4, most preferably within the range of 90:10 to 96:4, most preferably about 95:5.

11. The solid material according to any one of the previous claims wherein the material is a glassy solid.

12. The solid material according to any one of the previous claims wherein the material has an ionic conductivity at 25° C. of at least 0.1 mS/cm, preferably at least 0.25 mS/cm and a thermal stability of more than 110° C.

13. The solid material according to any one of the previous claims, preferably according to claim 12, wherein the material has an electronic conductivity of at least 5×10⁻⁵ mS/cm, preferably at least 7×10⁻⁵ mS/cm and a thermal stability of more than 110° C.

14. A method for preparing a solid material, preferably a solid material as defined in any one of claims 1-13, comprising the steps of:
(i) Providing the following precursors:
Li₂S
B₂S₃ and/or both of boron and sulfur;
Optionally B₂O₃; and
X wherein X represents Se, Te, In or combinations thereof;
(ii) Preparing a mixture comprising the precursors provided in step (i) wherein
in said mixture the molar ratio of the elements matches the general formula (I) as defined in any one of claims 1-7; or
in said mixture the molar ratio of the precursors matches the general formula (II) as defined in any one of claims 8-10 and in said mixture the molar ratio of A and B is as defined in any one of claims 8-10;
(iii) heat-treating the mixture prepared in step (ii) to obtain a melt; and
(iv) quenching the melt obtained in step (iii) to obtain the solid material, preferably the solid material as defined in any one of claims 1-13.

15. An electrochemical cell comprising the solid material as defined in any one of claims 1-13.

16. Use of the solid material as defined in any one of claims 1-13 as a coating for an electrochemical cell component, preferably a cathode.
